(19) United States
(12) Patent Application Publication
(10) Pub. No.: US 2021/0390388 A1
(43) Pub. Date: Dec. 16, 2021

(54) Convolutional Neural Networks In The Spectral Domain

(71) Applicant: Silicon Laboratories Inc., Austin, TX (US)

(72) Inventors: Javier Elenes, Austin, TX (US); Praveen Vangala, Austin, TX (US)

(21) Appl. No.: 16/901,637

(22) Filed: Jun. 15, 2020

(51) Int. Cl. G06N 3/08; G06N 3/04; G06F 17/14

(52) U.S. Cl. CPC G06N 3/08; G06F 17/142; G06N 3/04

(57) ABSTRACT

A system and method of implementing a convolutional neural network in the spectral domain is disclosed. Rather than performing convolution operations in the spatial domain, the inputs to the convolutional layer and the filter kernels are zero-padded and converted into the spectral domain. Once in the spectral domain, element wise multiplications are performed. The inverse Fourier Transform of the final output is then taken to return to the spatial domain. In certain embodiments, all filter kernels are learned in the spatial domain and are converted to the spectral domain at inference time in the convolutional neural network. In some embodiments a dimensionality reduction operation is applied in the spectral domain. In some embodiments, the conjugate symmetric filter kernels are learned directly in the spectral domain. In other embodiments, the learned spectral kernels apply various forms of dimensionality reduction such as puncturing, low-pass, high-pass, band-pass filtering operations.

This disclosure describes systems and methods for implementing convolutional neural networks in the spectral domain.

### BACKGROUND

Neural networks are used for a variety of activities. For example, neural networks can be used to identify objects, recognize audio commands, and recognize patterns in data.

In some embodiments, the neural network provides one or more outputs, which are related to the inputs. Examples may include predicting the steering angle needed by a self-driving automobile based on the visual image of the road ahead. A neural network may also be used to predict which of a fixed set of classes or categories input data belongs to. Examples may include calculating the probability that an image is one of a set of different animals. Another example is calculating the probability that an audio signal is one of a fixed set of speech commands.

In both instances, neural networks are typically constructed using a plurality of processing layers stacked on top of each other. These layers may perform linear and/or non-linear mathematical operations on their inputs. These layers may be fully connected layers, where each neuron from a previous stage connects to each neuron of the next layers with an associated weight. Alternatively, these layers may be convolutional layers, where, at each output, the input is convolved with a plurality of filters.

The convolution function is computationally intensive. For example, assume each channel has dimension N×N and each filter kernel is of dimension k×k. Further assume that there are I input channels and O output channels. In this environment, a total number of multiply operations is of the order I*O*N²*k². Assuming three input channels, 64 output channels, a filter kernel size of 5×5 and a channel dimension of 32×32, this results in over 5 million multiplication operations!

This may be prohibitive in smaller devices, such as IoT devices, with limited computation capability and a limited power budget.

Therefore, it would be beneficial if there were a system and method for implementing convolutional neural networks that was not power or computationally intensive. For example, it would be advantageous if the number of multiplication operations did not depend on the size of the filter kernels.

### SUMMARY

A system and method of implementing a convolutional neural network in the spectral domain is disclosed. Rather than performing convolution operations in the spatial domain, the inputs to the convolutional layer and the filter kernels are zero-padded and converted into the spectral domain. Once in the spectral domain, element wise multiplications are performed. The inverse Fourier Transform of the final output is then taken to return to the spatial domain. In certain embodiments, all filter kernels are learned in the spatial domain and are converted to the spectral domain at inference time in the convolutional neural network. In some embodiments, a dimensionality reduction operation is applied in the spectral domain. In some embodiments, the conjugate symmetric filter kernels are learned directly in the spectral domain. In other embodiments, the learned spectral kernels apply various forms of dimensionality reduction such as puncturing, low-pass, high-pass of band-pass filtering operations.

According to one embodiment, a method for implementing a processing layer of a neural network, wherein the neural network comprises a plurality of processing layers, wherein at least one of the plurality of layers comprises a convolutional layer, is disclosed. The method comprises providing an input array to the processing layer of the neural network; providing a plurality of filter kernels to the processing layer, each of the filter kernels having a size of k×k; padding the input array by adding at least (k−1) zeros to each dimension of the input array to form an expanded input array such that each dimension of the expanded input array is increased by at least (k−1); padding the expanded input array with additional zeros to form a padded input array such that each dimension of the padded input array is a power of 2; padding the plurality of filter kernels with zeros such that the padded filter kernels are the same dimension as the padded input array; performing a Fast Fourier Transform of the padded input array and the plurality of padded filter kernels to create a spectral input array and a plurality of spectral filter kernels; performing an element-wise multiplication of the spectral input array and each of the plurality of spectral filter kernels to create a plurality of spectral output arrays; performing an inverse Fast Fourier Transform to convert the spectral output arrays to spatial output arrays; and creating output channels from the spatial output arrays. In certain embodiments, the Fast Fourier Transform is performed utilizing Cooley-Tukey algorithm. In certain embodiments, radix-2 butterflies are used to perform Cooley-Tukey algorithm. In certain embodiments, the plurality of spectral filter kernels each comprises a first column, referred to as C column, a first row referred to as R row, an upper left quadrant, referred to as Q1 array, a lower left quadrant, referred to as Q2 array, an upper right quadrant that is a conjugate of a 180° rotation of the Q2 array, and a lower right quadrant that is a conjugate of a 180° rotation of the Q1 array. In some embodiments, the plurality of spectral filter kernels are trained by modifying the C column, the R row, the Q1 array and/or the Q2 array.

According to another embodiment, a method for implementing a processing layer of a neural network, wherein the neural network comprises a plurality of processing layers, wherein at least one of the plurality of layers comprises a convolutional layer, is disclosed. The method comprises providing an input array to the processing layer of the neural network; providing a plurality of filter kernels to the processing layer, each of the filter kernels having a size of k×k; padding the input array by adding at least (k−1) zeros to each dimension of the input array to form a padded input array such that each dimension of the padded input array is increased by at least (k−1); padding the plurality of filter kernels with zeros such that padded filter kernels are the same dimension as the padded input array; performing a Fast Fourier Transform of the padded input array and the plurality of padded filter kernels to create a spectral input array and a plurality of spectral filter kernels; performing an element-wise multiplication of the spectral input array and each of the plurality of spectral filter kernels to create a plurality of spectral output arrays; pooling the spectral output arrays to create pooled spectral output arrays, wherein the pooling is performed in a spectral domain; and performing an inverse Fast Fourier Transform to convert the pooled spectral output arrays to spatial output arrays. In some embodiments, the pooling is performed after the element-wise multiplication of the spectral input array and one of the plurality of spectral filter kernels. In certain embodiments, the pooling comprises performing an element-wise multiplication of each of the spectral output arrays and a conjugate-symmetric mask. In some embodiments, the conjugate-symmetric mask comprises a low pass filter, a high pass filter, a band pass filter or a punctured filter, wherein there are no adjacent non-zero elements. In certain embodiments, the plurality of spectral filter kernels each comprises a first column, referred to as C column, a first row referred to as R row, an upper left quadrant, referred to as Q1 array, a lower left quadrant, referred to as Q2 array, an upper right quadrant that is a conjugate of a 180° rotation of the Q2 array, and a lower right quadrant that is a conjugate of a 180° rotation of the Q1 array. In some embodiments, the plurality of spectral filter kernels are trained by modifying the C column, the R row, the Q1 array and/or the Q2 array.

According to another embodiment, a method for implementing a processing layer of a neural network, wherein the neural network comprises a plurality of processing layers, wherein at least one of the plurality of layers comprises a convolutional layer, is disclosed. The method comprises providing an input array to the processing layer of the neural network; providing a plurality of filter kernels to the processing layer, each of the filter kernels having a size of k×k; padding the input array by adding at least (k−1) zeros to each dimension of the input array to form expanded input array such that each dimension of the expanded input array is increased by at least (k−1); padding the expanded input array with additional zeros to form padded input array such that each dimension of the padded input array is a power of 2; padding the plurality of filter kernels with zeros such that padded filter kernels are the same dimension as the padded input arrays; performing a Fast Fourier Transform of the padded input array and the plurality of padded filter kernels to create a spectral input array and a plurality of spectral filter kernels; performing an element-wise multiplication of the spectral input array and each of the plurality of spectral filter kernels to create a plurality of spectral output arrays, wherein the element-wise multiplication is performed using a CORDIC; and pooling the spectral output arrays to create output channels. In certain embodiments, performing the element-wise multiplication comprises: converting an element of the spectral input array to polar coordinates using the CORDIC, wherein the polar coordinates comprise a first magnitude and a first phase; converting an element of one of the plurality of spectral filter kernels to polar coordinates using the CORDIC, wherein the polar coordinates comprise a second magnitude and a second phase; adding the first phase and the second phase to create a resulting phase; multiplying the first magnitude and the second magnitude to create a resulting magnitude; and converting the resulting magnitude and resulting phase to cartesian coordinates using the CORDIC. In certain embodiments, the resulting magnitude is generated using the CORDIC. In certain embodiments, the plurality of spectral filter kernels each comprises a first column, referred to as C column, a first row referred to as R row, an upper left quadrant, referred to as Q1 array, a lower left quadrant, referred to as Q2 array, an upper right quadrant that is a conjugate of a 180° rotation of the Q2 array, and a lower right quadrant that is a conjugate of a 180° rotation of the Q1 array. In some embodiments, the plurality of spectral filter kernels are trained by modifying the C column, the R row, the Q1 array and/or the Q2 array.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of a device that may be used to implement the convolutional neural network described herein;

FIG. 2 shows the architecture of a convolutional neural network;

FIG. 3 is a first embodiment of a processing layer of a convolutional neural network of FIG. 2;

FIG. 4 is an illustration showing the calculation of a Fast Fourier Transform using radix-2 butterflies;

FIG. 5 shows a N×N array that has undergone an FFT process;

FIG. 6 is a second embodiment of a processing layer of a convolutional neural network of FIG. 2;

FIGS. 7A-7D show four different masks that can be used for spectral pooling;

FIG. 8 shows another embodiment of a block diagram of a device that may be used to implement the convolutional neural network described herein;

FIG. 9A shows a first implementation of a CORDIC that can be used with the device of FIG. 8;

FIG. 9B shows a second implementation of a CORDIC that can be used with the device of FIG. 8;

FIG. 10 shows the various modes of the CORDIC shown in FIGS. 9A-9B; and

FIG. 11 is a third embodiment of a processing layer of a convolutional neural network using a CORDIC.

### DETAILED DESCRIPTION

As noted above, neural networks are good at recognizing patterns in data and making inferences and predictions from that data. In Internet of Things (IoT) applications, that data is often sensed by the device from a physical world. Some examples of neural network applications are:
identifying and locating particular objects in an image;
recognizing spoken words from audio waveforms; or
recognizing hand gestures from a variety of sensor readings.

Neural network inference involves the transformation of input data, such as an image, an audio spectrogram, or other sensed data, into inferred information. Such transformation typically involves non-linear operations to perform the activation functions. These activation functions may include exponential functions, sigmoid functions, hyperbolic tangent, and division among others. The neural network training operation also involves use of non-linear operations including logarithmic and exponential functions.

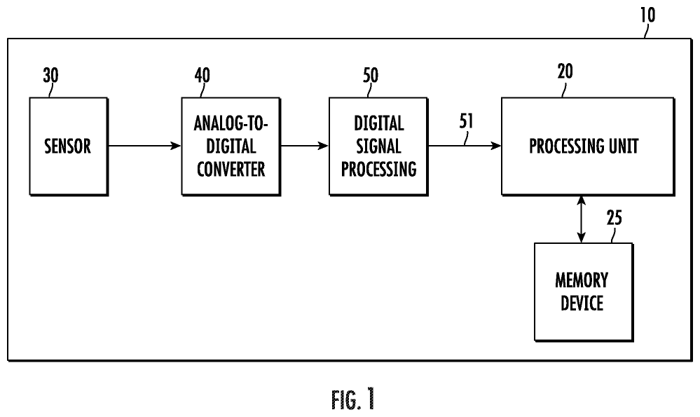

FIG. 1 shows a device that may be used to implement the neural network described herein. The device 10 has a processing unit 20 and an associated memory device 25. The processing unit 20 may be any suitable component, such as a microprocessor, embedded processor, an application specific circuit, a programmable circuit, a microcontroller, or another similar device. In certain embodiments, the processing unit 20 may be a neural processor. In other embodiments, the processing unit 20 may include both a traditional processor and a neural processor. The memory device 25 contains the instructions, which, when executed by the processing unit 20, enable the device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM. The instructions contained within the memory device 25 may be referred to as a software program, which is disposed on a non-transitory storage media. In certain embodiments, the software environment may utilize standard deep learning libraries, such as Tensorflow and Keras.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 1. The second computer readable non-transitory media may be a CDROM, FLASH memory or a different memory device, which is located remote from the device 10. The instructions contained on this second computer readable non-transitory media may be downloaded onto the memory device 25 to allow execution of the instructions by the device 10.

The device 10 may include a sensor 30 to capture data from the external environment. This sensor 30 may be a microphone, a camera or other visual sensor, touch device, or another suitable component.

The sensor 30 may be in communication with an analog to digital converter (ADC) 40. In certain embodiments, the output of the ADC is presented to a digital signal processing unit 50. The digital signal processing unit 50 may do some preprocessing on the signal such as filtering, FFT or other forms of feature extraction. In other embodiments, the output from the sensor 30 may be in digital format such that the ADC 40 and the digital signal processing unit 50 may be omitted.

While the processing unit 20, the memory device 25, the sensor 30, the ADC 40 and the digital signal processing unit 50 are shown in FIG. 1 as separate components, it is understood that some or all of these components may be integrated into a single electronic component. Rather, FIG. 1 is used to illustrate the functionality of the device 10, not its physical configuration.

Although not shown, the device 10 also has a power supply, which may be a battery or a connection to a permanent power source, such as a wall outlet.

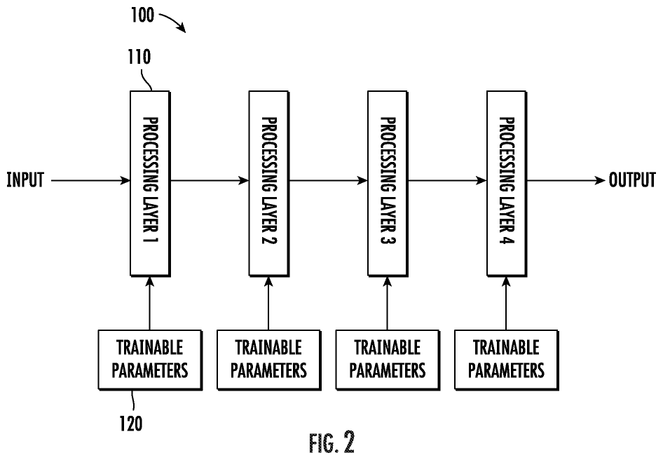

FIG. 2 shows a typical neural network 100. The neural network 100 comprises a plurality of processing layers 110. Each processing layer 110 comprises one or more operations, each of which performs some transformation of the inputs. Each processing layer 110 receives its inputs from the previous processing layer and performs some operation of those inputs. This operation is performed using one or more trainable parameters 120. For convolutional networks, each processing layer 110 may convolve its input with a plurality of filters to generate a plurality of outputs. In these embodiments, the trainable parameters may be the filter kernels or weights.

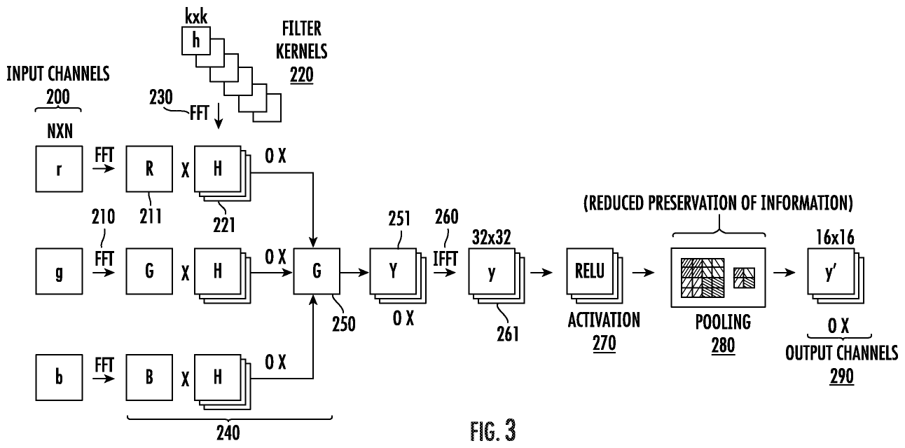

FIG. 3 shows a simplified diagram of processing layer 110 of the convolutional neural network 100.

Each processing layer 110 may have one or more input channels 200. For example, there may be I input channels. Each input channel is typically an input array. The size of each input array may be N×M, where N and M may be 32, 64 or another value.

First, the input array must be padded with (k−1) zeros along each dimension of the array, where k is the dimension of the filter kernels 220. For example, if k is equal to 5, four 0's will be added to each row of the input array. Further, four rows of zeros will be added to each column of the input array. In other words, the original input array is now expanded by four zeros in each direction. The additional zeros can be added in a number of numbers. For example, all of the additional zeros may be inserted at the beginning of each row or the end of each row. Alternatively, some of the additional zeros may be inserted at the beginning of each row with the remainder added to the end of the row. Of course, each row is padded in the same manner. Similarly, each column can be padded by inserting all of the zeros at the top of each column or the bottom of each column. Alternatively, some of the additional zeros may be inserted at the top of each column with the remainder added to the bottom of the column. Of course, each column is padded in the same manner. Thus, if the input array was originally 16×16, it is now 20×20. This may be referred as an expanded input array.

Next, the expanded input array may then be further padded so that each dimension is a power of 2. In other words, in the previous example, the expanded input array would be padded to be 32×32. This final array may be referred to as the padded input array. Note that while there are benefits of padding the expanded input array so that each dimension is a power of 2, there are embodiments where this step is not performed. In these embodiments, the expanded input array becomes the padded input array.

Next, each padded input array undergoes a Fast Fourier Transfer (FFT) process 210. The output of this FFT process 210 may be a spectral representation of the padded input array, referred to as the spectral input array 211.

Each processing layer 110 may also utilize a plurality of filter kernels 220. These filter kernels 220 typically have much smaller dimensions than the input arrays. The dimension of the filter kernels may be k×k. Additionally, there are typically a plurality of filter kernels for each input channel 200. For example, there may be O filter kernels that are used for each input channel 200. First, the filter kernels 220 are padded so that they are the same dimension as the padded input arrays. Then, the padded filter kernels undergo an FFT process 230. The output of this FFT process 230 may be a spectral representation of the padded filter kernels, referred to as a spectral filter kernel 221.

The spectral input array 211 then undergoes to an element-wise multiplication 240 with each of the spectral filter kernels 221, to form a plurality of the spectral output arrays. In other words, for each element of the spectral output array, the value is equal to the product of the corresponding element in the spectral input array 211, such as R(i,j) and the corresponding element in the spectral filter kernel 221, such as H(i,j). In other words; for each i and j, the corresponding value in the spectral output array is R(i,j)*H(i,j). Each channel will produce O spectral output arrays (i.e. one for each spectral filter kernel). If there are multiple input channels, the spectral output arrays from each input channel associated with a particular spectral filter kernel may undergo an addition operation 250 to produce the final spectral output array (Y), resulting in O different final spectral output arrays 251. These final spectral output arrays 251 then undergo an inverse FFT(IFFT) process 260.

The size of the resulting spatial output arrays 261 is the same of the padded spectral array. The IFFT process 260 implements an inverse Fast Fourier Transform of the same size as the FFT process 210. In certain embodiments, the result may have a dimension of 32×32, although other dimensions are also possible. The remaining portions of the processing layer 110 are identical to those used in traditional convolutional neural networks. For example, the spatial output arrays 261 may undergo an activation function 270, which may be a ReLU (Rectified Linear Unit) function. Finally, the spatial output arrays 261 may undergo a pooling function 280, which reduces the amount of information that is saved. In certain embodiment, the pooling function 280 takes the average of a sub-array or the maximum value of a sub-array and uses the value as the value to be added to the smaller final spatial output arrays. The result of all of these operations is the output channels 290, which may be a set of O final spatial output arrays, where the dimension of these final spatial output arrays is less than the size of the spatial output arrays 261.

Certain calculations required by this convolutional neural network may be optimized. For example, the FFT processes may be performed using the formula:

$$X ( k ) = {\sum }_{n = 0}^{N - 1} x ( n ) {e}^{- j 2 π kn \text{/} N}$$

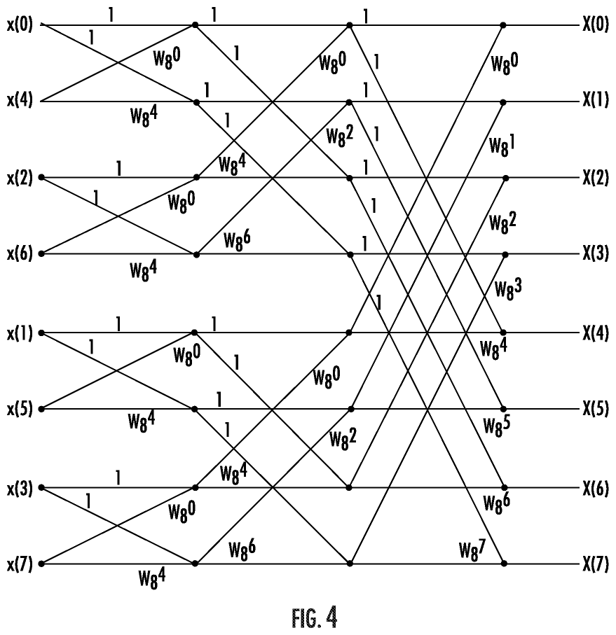

This formula requires on the order of N² multiplication operations. The number of multiplications may be reduced by utilizing the Cooley-Tukey algorithm. If radix-2 butterflies are used, the number of multiplication operations may be reduced to the order of (N/2)*log₂N. FIG. 4 shows the flow of calculations using radix-2 butterflies with an array having 8 elements.

The values that are disposed next to the various lines in FIG. 4 represent the weight of that line. In other words, a value of “1” indicates that the previous node is multiplied by 1 when going to the next node. Note that there are a plurality of twiddle factors. Each twiddle factor is defined as follows:

W_{N}^{k}=e^{-j2πk/N}

Note that while FIG. 4 shows a plurality of twiddle factors, this number can be reduced as follows:

W_{N}⁰=1

W_{N}⁴=−1

W_{N}⁵=−W_{N}¹

W_{N}⁷=−W_{N}³

If N is known, the twiddle factors are constants, which can be stored as constants in the memory device 25.

Further, a two dimensional spatial array may be converted to a two dimensional spectral array, as follows:

$$X ( p , q ) = {\sum }_{n = 0}^{N - 1} {\sum }_{m = 0}^{N - 1} x ( m , n ) {e}^{- j 2 π pm \text{/} N} {e}^{- j 2 π q n \text{/} N}$$

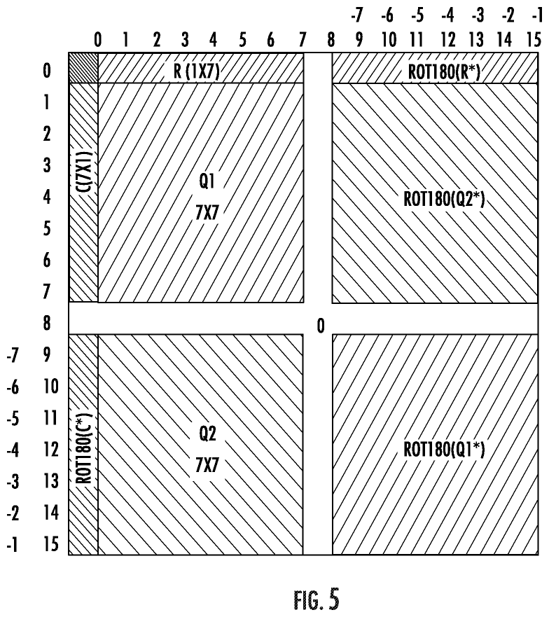

The resulting spectral array has several interesting properties, as shown in FIG. 5. FIG. 5 shows a N×N array, wherein N is 16. However, the following description applies to arrays of any dimension that is a power of 2.

First, the origin, or the value at the index X(0,0) is always a real number. Additionally, the values at indexes X(0, N/2); X(N/2,0) and X(N/2,N/2) are also always real numbers. The remaining elements are complex numbers. Throughout this disclosure, the array notation is defined as (row, column).

Second, the first row of the array (labelled row R) is unique from the rest of the array, and can be split into four parts; the origin, which is at index X(0,0), the midpoint, which is at X(0,N/2), the first portion which is located between the origin and the midpoint, and a second portion located at indices X(0,N/2+1) through X(0,N−1). As shown in FIG. 5, the second portion is the complex conjugate of a 180° rotation of the first portion. In other words, for 1<n<N/2, X(0,N−n)=X′(0,n), where * is used to represent the conjugate.

Third, the first column of the array (labelled column C) is unique from the rest of the array, and can be split into four parts; the origin, which is at index X(0,0), the midpoint, which is at X(N/2,0), the first portion which is located between the original and the midpoint, and a second portion located at indices X(N/2+1,0) through X(N-1,0). As shown in FIG. 5, the second portion is the conjugate of a 180° rotation of the first portion. In other words, for 1<n<N/2, X(N−n,0)=X*(n,0).

Further, due to the periodic nature of the FFT function, the lower right quadrant is the conjugate of a 180° rotation of the upper left quadrant (labelled Q1). Similarly, due to the periodic nature of the FFT function, the upper right quadrant is the conjugate of a 180° rotation of the lower left quadrant (labelled Q2).

The kernel coefficients can be learned directly in the spectral domain during training. In this case, the trainable parameters in FIG. 5 are X(0,0), column C, Q1 array, Q2 array, and row R. This structure of conjugate symmetry ensures that the IFFT produces real numbers.

These properties may be useful in the creation of masks, as described in more detail below.

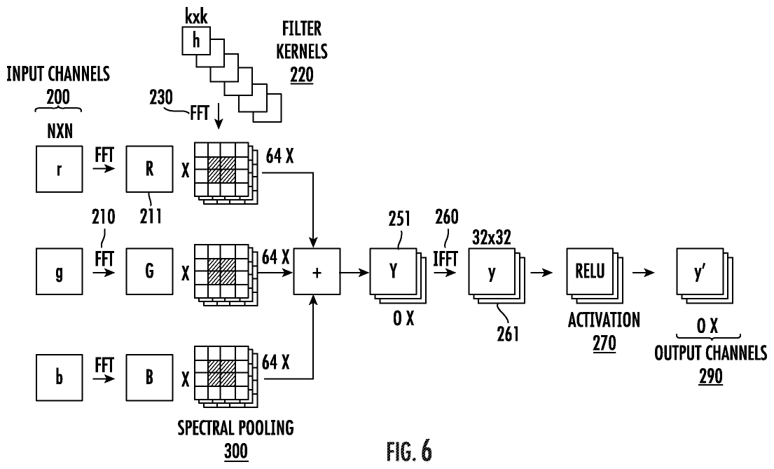

FIG. 6 shows a modification of the convolutional neural network of FIG. 3. In this figure, similar elements have been given identical reference designators.

In this embodiment, the pooling function 300 has been moved into the spectral domain, and is performed after the element-wise multiplication of the spectral input array 211 and each of the spectral filter kernels. The pooling function comprises performing an element-wise multiplication of the spectral output arrays with a mask, as described in detail below. This creates pooled spectral output arrays.

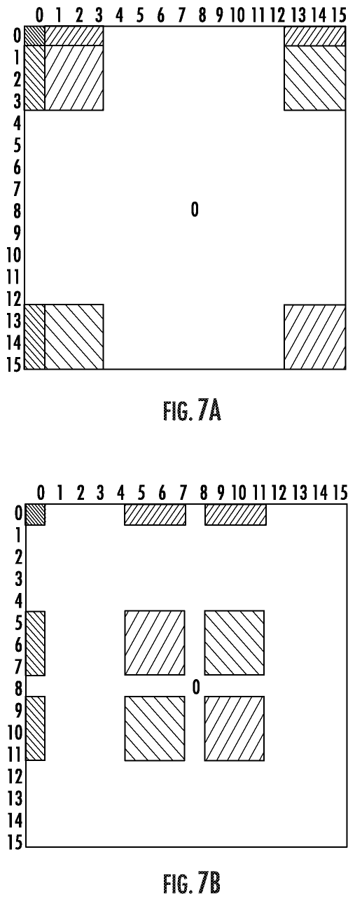

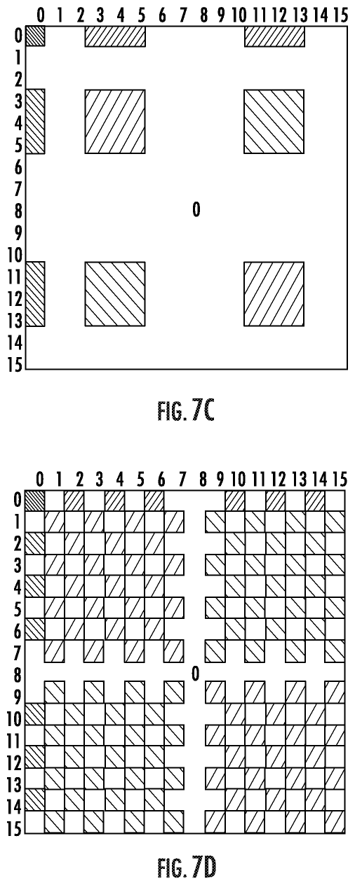

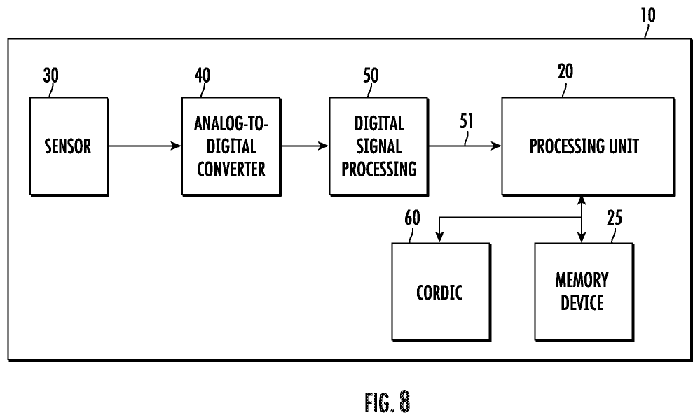

The pooling function 300 may be designed to achieve various effects. As is shown in FIG. 5, each element in an FFT array corresponds to a particular set of frequencies. Thus, the pooling function 300 may use arbitrary conjugate-symmetric masks to achieve different effects. FIG. 7A shows a mask that serves as a low pass filter, in that all of the high frequency elements are zeroed. FIG. 7B shows a mask that serves as a high pass filter, in that all of the low frequency elements are zeroed. FIG. 7C shows a mask that serves as a band pass filter, in that the lowest and highest of the high frequency elements are zeroed. FIG. 7D shows a punctured filter, where there are no adjacent non-zero elements.

In another embodiment, which may be utilized with the convolutional neural network of FIG. 3 or FIG. 6, the filter kernels are stored in the spectral domain. This eliminates the FFT process 230 from both of these convolutional neural networks. Thus, the computational load for the convolutional neural network may be reduced. The tradeoff is that the spectral representations of the filter kernels consume more memory space than the original spatial filter kernels. For example, a filter kernel in the spatial domain may have a size of 5×5. The spectral representation of this filter kernel may have a size of 16×16. Further, the spectral representation includes conjugate-symmetric complex components. Thus, rather than requiring 25 bytes of memory to store a filter kernel, each filter kernel (in the spectral domain) requires approximately 256 (due to conjugate symmetry) bytes of memory. If this concept is combined with the pooling function 300 of FIG. 6, the size of each spectral representation of a filter kernel can be further reduced. For example, in the low pass filter shown in FIG. 7A, only 50 elements have non-zero values. This is only four times more storage (because of the need to store both real and complex components) than is required by the spatial representation. Thus, by utilizing spectral pooling, it may be possible to economically store all of the filter kernels in the spectral domain and eliminate FFT process 230.

In a further embodiment, the filter kernels may be trained directly in the spectral domain. In some of these embodiments, the filter kernels may be designed to apply pooling in the spectral domain. Specifically, the loss function, which is defined as the difference between the computed outputs and ground truth, is used regardless of whether the filter kernels are stored in the spatial domain or the spectral domain. For training, the weight gradients are computed. These weight gradients represent how a change in weights affects the loss function. These are simply the partial derivatives of the loss function with respect to the weights. Weight gradients are computed for the spectral coefficients (origin, column C, row R, array Q1, and array Q2). During backpropagation the chain rule is used to compute gradients starting from the last layer and propagating backwards all the way to the first layer. To backpropagate through a layer, the function it implements must be differentiable. In this case the operations include FFT, multiply, add and IFFT. All of these are differentiable operations whose gradients can be computed.

While the above description discloses the use of Fast Fourier Transforms, other transformations may be used in the convolutional neural networks of FIG. 3 and FIG. 6. In one embodiment, a Hartley transformation is used in lieu of the FFT. A Hartley transformation is defined by the following equation:

$$X ( k ) = {\sum }_{n = 0}^{N - 1} x ( n ) [ cos ( \frac{2 π}{N} n k ) + sin ( \frac{2 π}{N} n k ) ]$$

This results in an array of all real values, and thus, the element wise multiplication requires fewer operations.

Alternatively, rather than FFT, a discrete cosine transformation (DCT) may be used. The DCT is defined as:

$$X ( k ) = {\sum }_{n = 0}^{N - 1} x ( n ) [ cos ( \frac{π}{N} ( n + \frac{1}{2} ) k ) ]$$

Again, like the Hartley transformation, this results in an array of all real values.

Either of these transformations may be used in place of the FFT processes 210, 230 and IFFT process 260 described above. In fact, any transformation from the special domain to the spectral domain may be used.

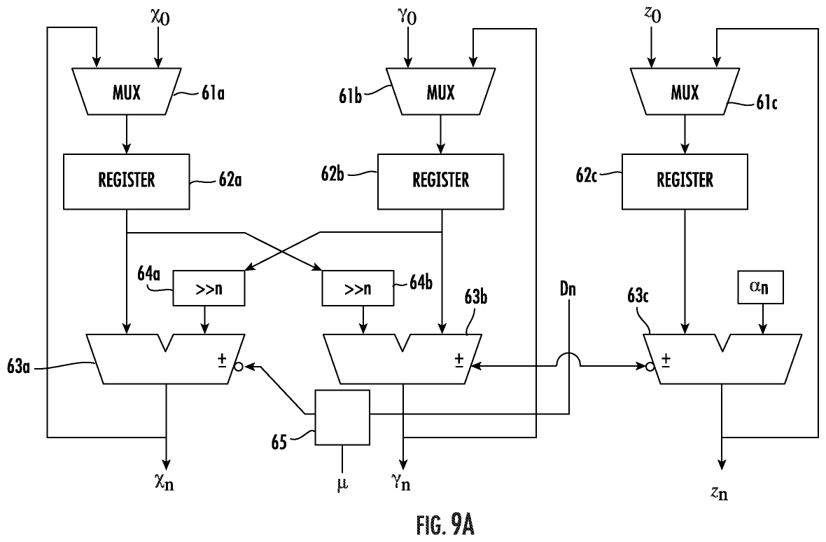

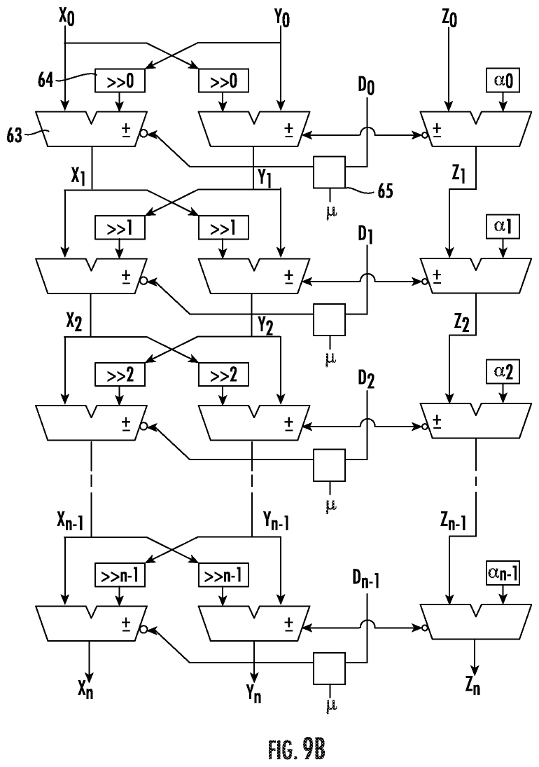

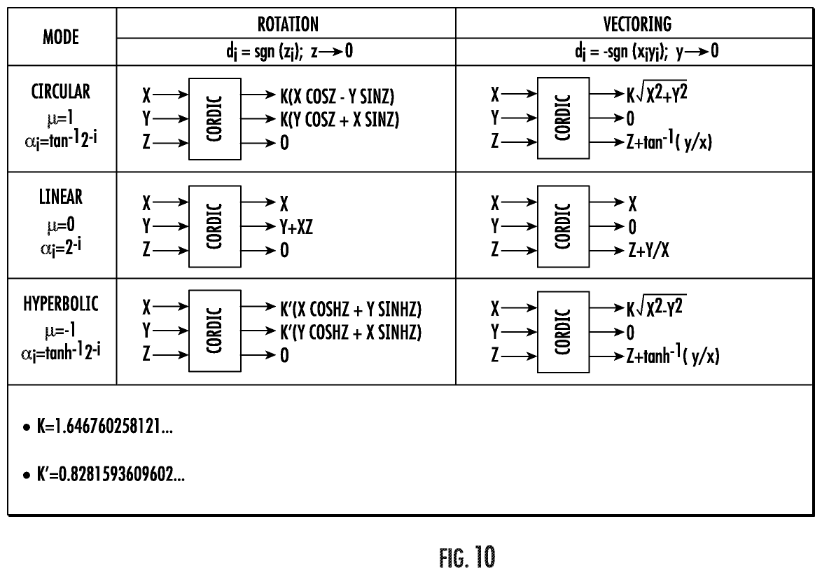

FIG. 8 shows another embodiment. In this embodiment, the device 10 includes a CORDIC. A block diagram of one stage of an iterative universal CORDIC is shown in FIG. 9A. A fully iterated universal CORDIC is shown in FIG. 9B. FIG. 10 shows the various operations that can be performed by the CORDIC 60 and also show the control inputs used for each operation.

Each stage of the CORDIC 60 has three data inputs, an Xₙ value, a Yₙ value and a Zₙ value. The first stage of the CORDIC 60 uses three new values, X₀, Y₀ and Z₀. Each subsequent stage simply uses the output from the previous stage. Each stage of the CORDIC also has three control inputs, which determine the function to be performed. These include Dₙ, αₙ, and μ. Each stage performs the following functions:

Xₙ₊₁=Xₙ−μ*Dₙ*Yₙ*2⁻ⁿ;

Yₙ₊₁=Yₙ+DₙXₙ*2⁻ⁿ; and

Zₙ₊₁=Zₙ−Dₙ*αₙ.

Note that while the αₙ terms may involve complex functions, such as exponents, arctangents and hyperbolic arc tangents, each of these values is actually a constant. Therefore, there is no computation involved in generating the αₙ terms. In fact, the CORDIC uses only addition and shift operations.

The accuracy of the CORDIC is dependent on the number of iterations that are performed. A rule of thumb is that each iteration contributes one significant digit. Thus, for an 8 bit value, the operations listed above are repeated 8 times.

It is noted that FIG. 9A shows that a stage of the CORDIC 60 allows the output to be returned to the input. A set of multiplexers 61a, 61b, 61c are used to select between the initial value of the data (which is used only for the first iteration) and the previous value of the data, which is used by all other iterations. A set of registers 62a, 62b, 62c is used to capture the value of those inputs. An accumulator 63a, 63b, 63c is also associated with each data input. Note that each accumulator 63a, 63b, 63c is capable of performing addition or subtraction, depending on the state of the control signal. The X and Y calculations also include a shift register 64a, 64b. Further, the X calculation is also dependent on the value of p. Logic circuit 65 uses the value of p, in conjunction with the value of Di, to create a control signal to the accumulator 63a which determines whether the accumulator 63a adds, subtracts or ignores the output from the shift register 64a.

In another embodiment, the CORDIC 60 may not use the same stage iteratively. For example, in another embodiment, the CORDIC may be designed with a plurality of stages, such as is shown in FIG. 9B. In this embodiment, the three data inputs are entered into the first stage and the final result is found at the output of the last stage.

Finally, although FIG. 8 shows a single CORDIC 60, it is noted that multiple CORDICs may be disposed in the device 10. The use of more CORDICs may allow operations to occur in parallel.

While the processing unit 20, the memory device 25, the sensor 30, the digital signal processing unit 50, the ADC 40, the CORDIC 60 are shown in FIG. 8 as separate components, it is understood that some or all of these components may be integrated into a single electronic component. Rather, FIG. 8 is used to illustrate the functionality of the device 10, not its physical configuration. Further, the CORDIC 60 may be implemented in software, in certain embodiments.

Having described the structure and operation of a CORDIC 60, its function in the present disclosure will now be described. Note that in FIGS. 3 and 6, each element of the spectral input array must be multiplied by the corresponding element in the spectral filter kernel. Since each element in these arrays is a complex number, a piece-wise multiplication requires 4 multiplication operations and 2 addition operations. For example, 2+2i multiplied by 3+4i yields (2*3−2*4)+(2*4+2*3)*i, which reduces to −2+14i.

The use of CORDIC 60 reduces the complexity of these operations. Specifically, a complex number may be expressed in polar coordinates as an amplitude and a phase. The multiplication of two numbers, in the polar coordinates requires one multiplication and one addition. Thus, the use of a CORDIC may be used to convert the complex numbers to polar coordinates, and then convert the result back to cartesian coordinates.

The following shows an example of this process. First, referring to FIG. 10, it is noted that in circular vectoring mode, the CORDIC provides the magnitude and phase of two numbers. Specifically, for a complex number α+βi, if the x input is α, the y input is β, and the z input is 0, the first output will be the magnitude, \sqrt{α²+β²}, multiplied by a constant. The third output will be the phase of the complex number. If this operation is performed by two complex numbers, their phases may be added together, either using the processing unit 20, or using the CORDIC in linear rotation mode, where the phases are supplied on inputs x and y, while the z input is set to 1. Similarly, their magnitudes may be multiplied together, either using the processing unit 20, or using the CORDIC in linear rotation mode, where the magnitudes are supplied on inputs x and z, while the y input is set to 0. Note that the resulting product will be multiplied by the constant K². This can be corrected by using the CORDIC 60 in linear vectoring mode, where the x input is the constant K², the y input is the resulting product, and the z input is 0. The third output will be the product of the two magnitudes, without the scale factor. In another embodiment, the scale factor is not eliminated at this time.

This resulting magnitude and phase can then be converted back to cartesian coordinates by placing the CORDIC 60 in circular rotation mode. The x input is the resulting magnitude, the y input is 0 and the z input is the resulting phase. The first output is the real part and the second output is the imagery part.

Using the above example, 2+2i can be expressed as magnitude=2.83, phase=45°. These results can be found using the CORDIC 60 in circular vectoring mode, as described above. Similarly, 3+4i can be expressed as magnitude=5, phase=53.13°. The magnitudes can then be multiplied together to yield 14.14. The phases can be added to yield, 98.13°. This value that then input to the CORDIC 60 in circular rotation mode, where the x input is 14.14 and the z input is 98.13°. The result is as follows. The first output is −2 (multiplied by a scale factor) and the second output is 14 (multiplied by a scale factor). The scale factor can be eliminated by using the CORDIC in linear vectoring mode, as described above.

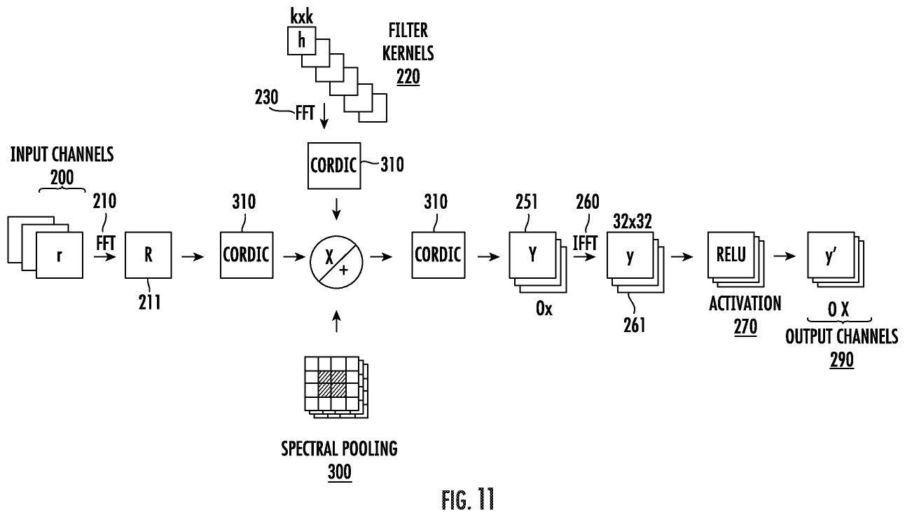

The placement of the CORDIC 310 in the neural network is illustrated in FIG. 11. Elements of the spectral input array are processed by CORDIC 310. Additionally, elements of the spectral filter kernel are processed by the CORDIC 310. The results are added and multiplied as described above. The final result is then processed by a CORDIC 310 to convert the result back to cartesian coordinates, as shown. These final spectral output arrays then undergo an inverse FFT(IFFT) process 260.

Thus, the present system defines a device 10 that generates an output based on one or more inputs from the sensor 30. This output may be a classification or a value related to the inputs. This output is generated by utilizing a neural network 100, which comprises one or more processing layers, wherein at least one of the processing layers comprises a convolutional layer. The convolutional layer transforms its inputs to the spectral domain, performs the convolution in the spectral domain and then returns the results to the spatial domain.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method for implementing a processing layer of a neural network, wherein the neural network comprises a plurality of processing layers, wherein at least one of the plurality of layers comprises a convolutional layer, the method comprising:
providing an input array to the processing layer of the neural network;
providing a plurality of filter kernels to the processing layer, each of the filter kernels having a size of k×k;
padding the input array by adding at least (k−1) zeros to each dimension of the input array to form an expanded input array such that each dimension of the expanded input array is increased by at least (k−1);
padding the expanded input array with additional zeros to form a padded input array such that each dimension of the padded input array is a power of 2;
padding the plurality of filter kernels with zeros such that the padded filter kernels are the same dimension as the padded input array;
performing a Fast Fourier Transform of the padded input array and the plurality of padded filter kernels to create a spectral input array and a plurality of spectral filter kernels;
performing an element-wise multiplication of the spectral input array and each of the plurality of spectral filter kernels to create a plurality of spectral output arrays;
performing an inverse Fast Fourier Transform to convert the spectral output arrays to spatial output arrays; and
creating output channels from the spatial output arrays.

2. The method of claim 1, wherein the Fast Fourier Transform is performed utilizing Cooley-Tukey algorithm.

3. The method of claim 2, wherein radix-2 butterflies are used to perform Cooley-Tukey algorithm.

4. The method of claim 1, wherein the plurality of spectral filter kernels each comprises a first column, referred to as C column, a first row referred to as R row, an upper left quadrant, referred to as Q1 array, a lower left quadrant, referred to as Q2 array, an upper right quadrant that is a conjugate of a 180° rotation of the Q2 array, and a lower right quadrant that is a conjugate of a 180° rotation of the Q1 array.

5. The method of claim 4, wherein the plurality of spectral filter kernels are trained by modifying the C column, the R row, the Q1 array and/or the Q2 array.

6. A method for implementing a processing layer of a neural network, wherein the neural network comprises a plurality of processing layers, wherein at least one of the plurality of layers comprises a convolutional layer, the method comprising:
providing an input array to the processing layer of the neural network;
providing a plurality of filter kernels to the processing layer, each of the filter kernels having a size of k×k;
padding the input array by adding at least (k−1) zeros to each dimension of the input array to form a padded input array such that each dimension of the padded input array is increased by at least (k−1);
padding the plurality of filter kernels with zeros such that padded filter kernels are the same dimension as the padded input array;
performing a Fast Fourier Transform of the padded input array and the plurality of padded filter kernels to create a spectral input array and a plurality of spectral filter kernels;
performing an element-wise multiplication of the spectral input array and each of the plurality of spectral filter kernels to create a plurality of spectral output arrays;
pooling the spectral output arrays to create pooled spectral output arrays, wherein the pooling is performed in a spectral domain; and
performing an inverse Fast Fourier Transform to convert the pooled spectral output arrays to spatial output arrays.

7. The method of claim 6, wherein the pooling is performed after the element-wise multiplication of the spectral input array and one of the plurality of spectral filter kernels.

8. The method of claim 7, wherein the pooling comprises performing an element-wise multiplication of each of the spectral output arrays and a conjugate-symmetric mask.

9. The method of claim 8, wherein the conjugate-symmetric mask comprises a low pass filter.

10. The method of claim 8, wherein the conjugate-symmetric mask comprises a high pass filter.

11. The method of claim 8, wherein the conjugate-symmetric mask comprises a band pass filter.

12. The method of claim 8, wherein the conjugate-symmetric mask comprises a punctured filter wherein there are no adjacent non-zero elements.

13. The method of claim 6, wherein the plurality of spectral filter kernels each comprises a first column, referred to as C column, a first row referred to as R row, an upper left quadrant, referred to as Q1 array, a lower left quadrant, referred to as Q2 array, an upper right quadrant that is a conjugate of a 180° rotation of the Q2 array, and a lower right quadrant that is a conjugate of a 180° rotation of the Q1 array.

14. The method of claim 13, wherein the spectral filter kernels are trained by modifying the C column, the R row, the Q1 array and/or the Q2 array.

15. A method for implementing a processing layer of a neural network, wherein the neural network comprises a plurality of processing layers, wherein at least one of the plurality of layers comprises a convolutional layer, the method comprising:
providing an input array to the processing layer of the neural network;
providing a plurality of filter kernels to the processing layer, each of the filter kernels having a size of k×k;
padding the input array by adding at least (k−1) zeros to each dimension of the input array to form expanded input array such that each dimension of the expanded input array is increased by at least (k−1);
padding the expanded input array with additional zeros to form padded input array such that each dimension of the padded input array is a power of 2;
padding the plurality of filter kernels with zeros such that padded filter kernels are the same dimension as the padded input arrays;
performing a Fast Fourier Transform of the padded input array and the plurality of padded filter kernels to create a spectral input array and a plurality of spectral filter kernels;
performing an element-wise multiplication of the spectral input array and each of the plurality of spectral filter kernels to create a plurality of spectral output arrays, wherein the element-wise multiplication is performed using a CORDIC; and
pooling the spectral output arrays to create output channels.

16. The method of claim 15, wherein performing the element-wise multiplication comprises:
converting an element of the spectral input array to polar coordinates using the CORDIC, wherein the polar coordinates comprise a first magnitude and a first phase;
converting an element of one of the plurality of spectral filter kernels to polar coordinates using the CORDIC, wherein the polar coordinates comprise a second magnitude and a second phase;
adding the first phase and the second phase to create a resulting phase;
multiplying the first magnitude and the second magnitude to create a resulting magnitude; and
converting the resulting magnitude and resulting phase to cartesian coordinates using the CORDIC.

17. The method of claim 16, wherein the resulting magnitude is generated using the CORDIC.

18. The method of claim 15, wherein the plurality of spectral filter kernels each comprises a first column, referred to as C column, a first row referred to as R row, an upper left quadrant, referred to as Q1 array, a lower left quadrant, referred to as Q2 array, an upper right quadrant that is a conjugate of a 180° rotation of the Q2 array, and a lower right quadrant that is a conjugate of a 180° rotation of the Q1 array.

19. The method of claim 18, wherein the spectral filter kernels are trained by modifying the C column, the R row, the Q1 array and/or the Q2 array.
